(19) United States
(12) Patent Application Publication
(10) Pub. No.: US 2016/0206176 A1
(43) Pub. Date: Jul. 21, 2016

(54) KITCHEN ACCESSORY SYSTEMS

(71) Applicant: Kohler Co., Kohler, WI (US)

(72) Inventor: Niels Eilmus, Sheboygan, WI (US)

(21) Appl. No.: 14/997,061

(22) Filed: Jan. 15, 2016

Related U.S. Application Data
(60) Provisional application No. 62/103,899, filed on Jan. 15, 2015.

(51) Int. Cl. A47L 19/04; A47J 47/20

(52) U.S. Cl. CPC A47L 19/04; A47J 47/20

(57) ABSTRACT

A dish mat includes a middle layer and a plurality of ribs. The middle layer has a top surface and a bottom surface. The plurality of ribs extend from each of the top and bottom surfaces of the middle layer. The plurality of ribs are spaced laterally apart from each other such that the plurality of ribs and the middle layer collectively define a plurality of upper and lower channels.

### CROSS-REFERENCE TO RELATED PATENT APPLICATIONS

This application claims the benefit of and priority to U.S. Provisional Application No. 62/103,899, filed Jan. 15, 2015, the entire disclosure of which is incorporated by reference herein.

### BACKGROUND

The present application relates generally to kitchen accessory systems, and more specifically, to kitchen accessory systems including a dish mat for use in conjunction with dishpans, sinks, countertops, and the like.

Generally speaking, a dish mat can be used in a sink basin or a dishpan to, for example, protect and support dishware or other kitchen accessories (e.g., pots, pans, drinking glasses, etc.), such as when cleaning the dishware or kitchen accessories. Furthermore, dish mats can be used on a countertop or a tabletop to provide an area or surface for holding wet kitchen accessories to facilitate drying of these accessories. However, most conventional dish mats are limited in that they merely provide a flat surface to set dishware or other kitchen accessories on. That is, conventional mats are not configured to work in conjunction with dishpans and sink basins to enable standing of plates or other kitchen accessories within the dishpan or sink. Furthermore, some conventional mats are stiff and difficult to store, and are not sufficiently soft and flexible to permit ease of storage and use in other applications (e.g., other sinks having different shapes/contours, sizes, etc.). In addition, most mats do not include features that can facilitate draining of fluids (e.g., water, liquid soap, etc.) and/or drying of kitchen accessories.

Accordingly, it would be advantageous to provide a kitchen accessory system including a dish mat that can enable standing of plates and other kitchen accessories, that is soft and flexible to permit ease of storage and use in a variety of applications, and that can facilitate draining of fluids and/or drying of various kitchen accessories. These and other advantageous features will become apparent to those reviewing the present disclosure and drawings.

### SUMMARY

One embodiment relates to a dish mat including a middle layer and a plurality of ribs. The middle layer has a top surface and a bottom surface. The plurality of ribs extend from each of the top and bottom surfaces of the middle layer. The plurality of ribs are spaced laterally apart from each other such that the plurality of ribs and the middle layer collectively define a plurality of upper and lower channels.

Another embodiment relates to a dish mat for a sink basin including a middle layer and a plurality of ribs. The middle layer includes a top surface and a bottom surface. The plurality of ribs extend outwardly from each of the top and bottom surfaces of the middle layer. The plurality of ribs are spaced laterally apart from each other such that the plurality of ribs and the middle layer collectively define a plurality of upper and lower channels. The plurality of upper and lower channels are each configured to provide vertical and lateral support for a kitchen accessory to enable standing of the kitchen accessory in a substantially upright direction within the sink basin, and direct fluid outwardly away from the dish mat.

Yet another embodiment relates to a dish mat including a middle layer and a plurality of ribs. The middle layer has a top surface and a bottom surface. The plurality of ribs project from the top and bottom surfaces of the middle layer and extend continuously between outermost side peripheries of the mat. The plurality of ribs are spaced laterally apart from each other such that the plurality of ribs and the middle layer collectively define a plurality of upper and lower channels. The plurality of upper and lower channels are each configured to direct fluid outwardly away from the dish mat.

### BRIEF DESCRIPTION OF THE DRAWINGS

FIG. 1 is a perspective view of a dishpan accessory system including a mat according to an exemplary embodiment.

FIG. 2 is a perspective view of a sink accessory system including a mat according to another exemplary embodiment.

FIG. 3 is a perspective view of a mat shown on a countertop according to yet another exemplary embodiment.

FIG. 4A is a perspective view of a mat according to an exemplary embodiment.

FIG. 4B is a top view of the mat of FIG. 4A.

FIG. 4C is a side view of the mat of FIG. 4A.

FIG. 4D is a detail view of the mat of FIG. 4C.

FIG. 5 is a perspective view of the mat of FIG. 4A shown in a storage position within a sink basin, according to an exemplary embodiment.

FIG. 6 is a perspective view of the mat of FIG. 4A shown in another storage position, according to another exemplary embodiment.

FIGS. 7A-7C are perspective views of an assembly sequence for hanging a mat, according to an exemplary embodiment.

### DETAILED DESCRIPTION

Referring generally to the FIGURES, disclosed herein are kitchen accessory systems including a dish mat configured for use in conjunction with dishpans, sinks, countertops, or other similar environments that enable standing of dishware (e.g., plates, saucers, etc.), facilitate draining of fluids and/or drying of various kitchen accessories (e.g., pots, pans, dishware, plates, utensils, drinking glasses, etc.), provide a soft, flexible surface for cleaning various kitchen accessories, and are sufficiently flexible to permit ease of storage and use in a variety of different applications (e.g., sinks having different shapes and contours, etc.).

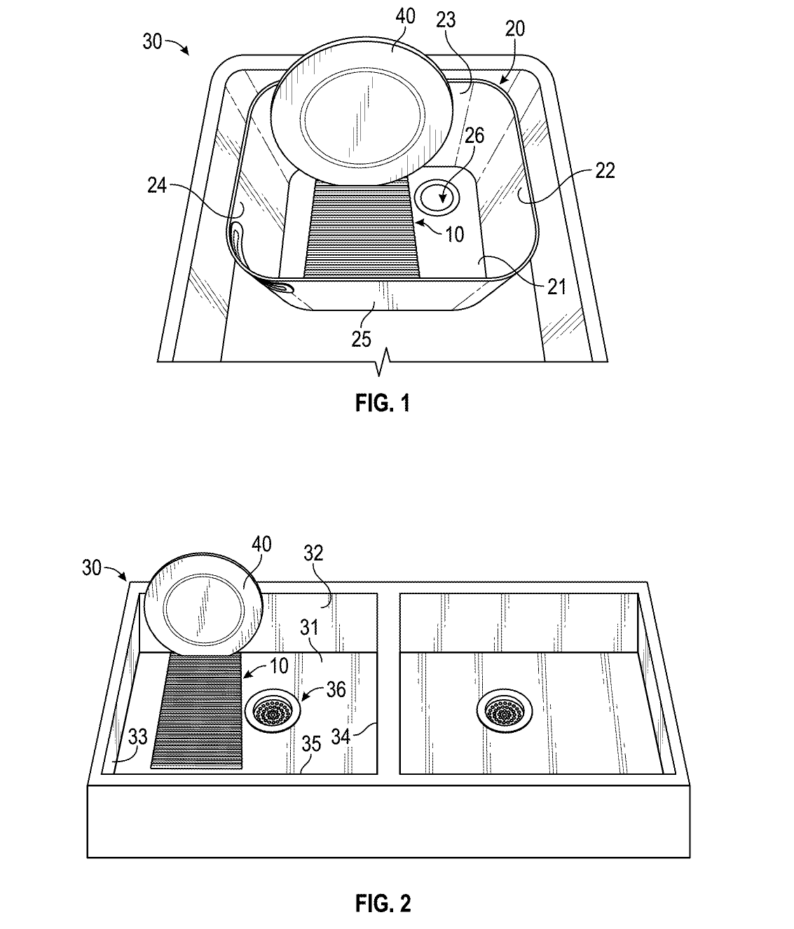

According to an exemplary embodiment shown in FIG. 1, a kitchen accessory system shown as a dishpan accessory system includes a mat 10 (e.g., a dish mat, etc.) and a dishpan 20. The dishpan 20 is shown disposed within, for example, a sink basin 30. The dishpan 20 is configured to provide an area for cleaning various kitchen accessories and/or holding one or more kitchen accessories. According to other exemplary embodiments, the dishpan 20 can be used as a stand-alone basin or tub. As shown in FIG. 1, the mat 10 is disposed within the dishpan 20 along a bottom wall 21 of the dishpan. In this position, the mat 10 is configured to support one or more kitchen accessories, such as, for example, a plate 40 in a substantially upright direction (e.g., vertical position) within the dishpan 20. The mat 10 also provides an adaptable support surface defined by a plurality of ribs for supporting one or more kitchen accessories within the dishpan 20. An upper surface of each of the ribs collectively defines an adaptable working surface that is soft and flexible to facilitate cleaning of various kitchen accessories (e.g., pots, pans, dishware, glasses, etc.) without damaging the dishpan and/or the accessories. Each of the ribs are connected by a middle layer that collectively defines a plurality of upper and lower channels. The upper and lower channels are configured to direct fluids (e.g., water, dish soap, etc.) within the dishpan 20 to facilitate draining of the fluids away from the mat 10.

As shown in FIG. 1, the dishpan 20 includes a bottom wall 21 coupled to interconnected sidewalls 22, 23, 24, and 25. The bottom wall 21 includes a drain 26 located offset from a center of the dishpan 20, adjacent the sidewall 22. The dishpan 20 has a generally rectangular shape, although the dishpan 20 may have other shapes (e.g., circular, octagonal, etc.), according to other exemplary embodiments. The dishpan 20 may be made from any semi-rigid or rigid material or combinations of materials suitable for use in a kitchen environment, such as, for example, a plastic, a ceramic, a metal, or any other suitable material. The dishpan 20 is configured to receive the mat 10 along the bottom wall 21 between the drain 26 and the sidewall 24 to form the dishpan accessory system. The dishpan accessory system is configured to assist a user with cleaning of various kitchen accessories by providing a soft, flexible working surface defined by the mat 10. The dishpan accessory system is further configured to enable standing of various kitchen accessories (e.g., plates, saucers, trays, etc.) and to facilitate the draining of various fluids within the dishpan 20, via the mat 10. The mat 10 can be selectively removed from the dishpan 20 and/or arranged in another suitable position within the dishpan.

Referring now to FIG. 2, a kitchen accessory system shown as a sink accessory system includes a sink basin 30 and a mat 10 (e.g., dish mat, etc.). The mat 10 is shown disposed within the sink basin 30 along a bottom wall 31 of the sink basin. The mat 10 is positioned, for example, adjacent a partition wall 32 of the sink basin 30, between a drain 36 and a sidewall 33. Similar to the embodiment shown in FIG. 1, the mat 10 is configured to support one or more kitchen accessories, such as, for example, a plate 40 in a substantially upright direction (e.g., vertical position) within the sink basin 30. The mat 10 also provides an adaptable surface defined by a plurality of ribs for supporting one or more kitchen accessories within the sink basin 30. An upper surface of the ribs defines an adaptable working surface that is soft and flexible to facilitate cleaning of various kitchen accessories (e.g., pots, pans, dishware, glasses, etc.) without damaging the sink basin and/or the accessories. The mat 10 can also direct fluids (e.g., water, dish soap, etc.) flowing within the sink basin 30 toward a drain 36 via the upper and/or lower channels of the mat, as described above with reference to the embodiment of FIG. 1.

As shown in FIG. 2, the sink basin 30 includes a bottom wall 31 coupled to interconnected sidewalls 33, 34, 35 and a partition wall 32. The bottom wall 31 includes a drain 36 disposed therein. The sink basin 30 has a generally rectangular shape, although the sink basin 30 may have other shapes (e.g., circular, octagonal, etc.), according to other exemplary embodiments. The sink basin 30 may be made from any semi-rigid or rigid material or combinations of materials suitable for use in a kitchen environment, such as, for example, a plastic, a ceramic, a metal, or any other suitable material. The sink basin 30 is configured to receive the mat 10 along the bottom wall 31 between the drain 36 and, for example, the sidewall 33 to form the sink accessory system. The sink accessory system is configured to assist a user with cleaning of various kitchen accessories by providing a soft, flexible working surface defined by the mat 10. The accessory system is further configured to enable standing of various kitchen accessories (e.g., plates, saucers, trays, etc.) and to facilitate the draining of various fluids within the sink basin 30, similar to the embodiment of FIG. 1 described above. The mat 10 can be selectively removed from the sink basin 30 and/or arranged in another suitable position within the sink basin or in another area of a kitchen (e.g., on a countertop, a tabletop, in a dishpan, etc.).

Referring now to FIG. 3, a mat 10 is shown disposed on a countertop 50 according to another exemplary embodiment. In this embodiment, the mat 10 is configured to provide a surface to facilitate drying of various kitchen accessories, such as, for example, one or more drinking glasses 60, although the mat 10 can facilitate drying of other types of kitchen accessories, according to other exemplary embodiments. The mat 10 can be selectively placed on a planar or a non-planar support surface, such as the countertop 50. One or more kitchen accessories (e.g., pots, pans, drinking glasses, dishware, utensils, etc.) may be placed on an upper surface of the mat 10 defined by the plurality of ribs of the mat. The mat 10 is configured to support the kitchen accessories and to receive/direct fluids from the kitchen accessories to facilitate drying of the accessories. According to other exemplary embodiments, the mat 10 may be placed on another type of planar or non-planar surface in a kitchen environment to facilitate drying and/or storage of various kitchen accessories, such as a tabletop, a work bench, a cutting board, or the like.

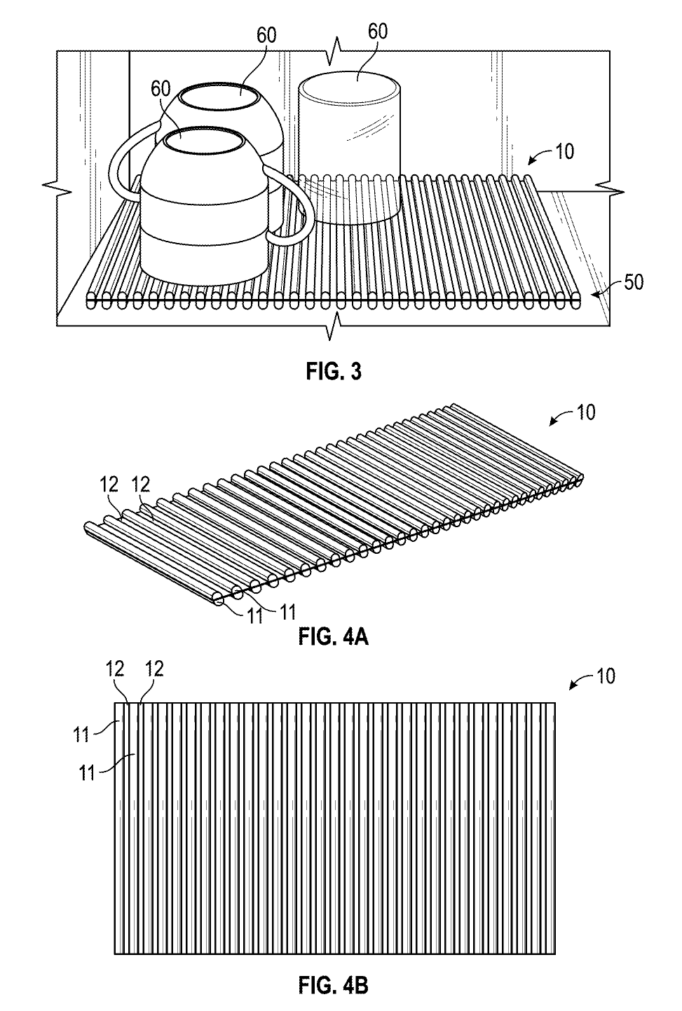

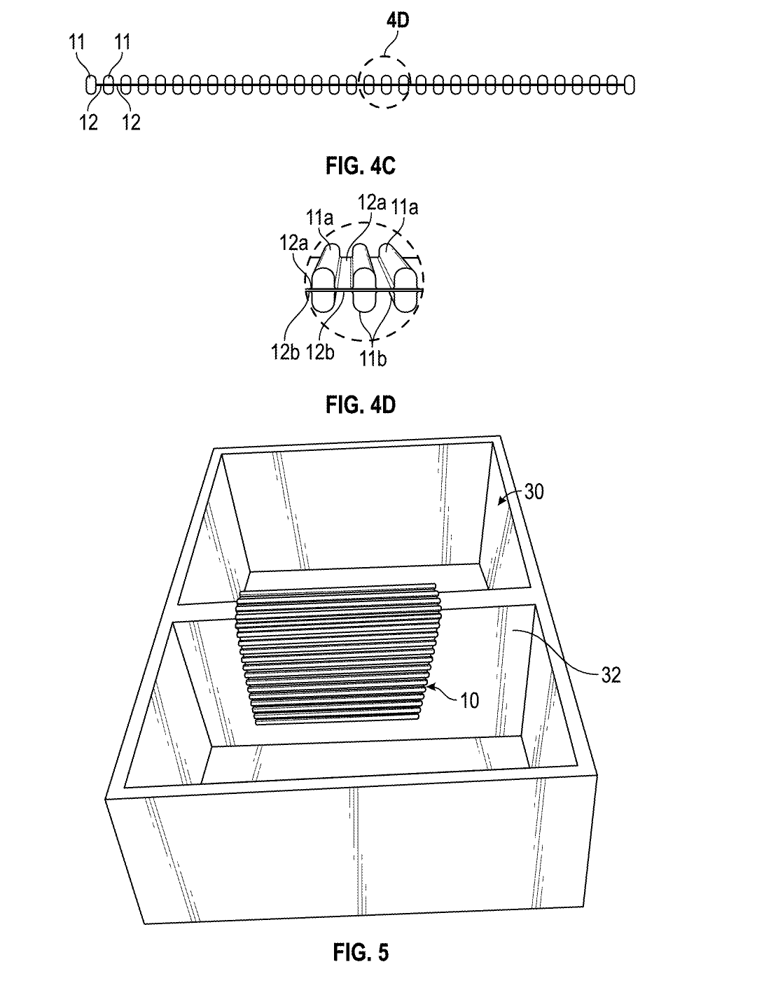

According to an exemplary embodiment shown in FIGS. 4A-4D, the mat 10 has a generally rectangular shape, although the mat 10 may have other shapes (e.g., circular, octagonal, etc.) according to other exemplary embodiments. As shown in FIGS. 4A-4D, the mat 10 includes a plurality of ribs 11 (e.g., ridges, protrusions, peaks, etc.) connected by a middle layer 12 (e.g., webbing, etc.). Each of the ribs 11 extend continuously between outermost side peripheries of the mat 10. The ribs 11 are spaced laterally apart from each other, which in conjunction with the middle layer 12, collectively defines a plurality of upper and lower channels of the mat 10 (i.e., between each pair of ribs 11). The upper and lower channels extend continuously between the outermost side peripheries of the mat 10 to facilitate evacuation of fluids therein. A pair of ribs 11 and a portion of the middle layer 12 are also configured to provide vertical and lateral support for various dishware (e.g., plates, saucers, etc.) to enable standing of the dishware within, for example, a dishpan 20 or a sink basin 30.

According to the exemplary embodiment shown in FIGS. 4B-4C, the mat 10 has a length of about 11.75″ (inches) and a width of about 7″ (inches). According to other exemplary embodiments, the mat 10 may be longer or wider depending on the particular application of the mat 10. As shown in FIG. 4B, the ribs 11 are spaced equidistant from each other and are arranged perpendicular to the middle layer 12. This arrangement allows for the mat 10 to be used in various kitchen accessory systems, such as dishpan accessory system or sink accessory system, while permitting the draining of fluids within those systems. For example, referring again to the systems of FIGS. 1-2, the mat 10 is configured such that it can be placed within the dishpan 20 or the sink basin 30 such that the respective drains 26, 36 are not obstructed by the mat 10. Furthermore, the mat 10 can fit within the dishpan/sink basin such that the ribs 11 (i.e., the upper and lower channels) are oriented to direct fluids toward the respective drains to facilitate draining within each of those systems. That is, the upper and lower channels defined by the ribs 11 and the middle layer 12 can direct fluids toward each of the respective drains 26, 36.

FIG. 4C illustrates a side view of the mat 10 of FIG. 4B. As shown in FIG. 4C, the ribs 11 have an overall height of about 0.40″ (inches), according to an exemplary embodiment, although the ribs 11 may have a larger or a smaller height, according to other exemplary embodiments. FIG. 4D is a detail view of the mat 10 of FIG. 4C. As shown in FIG. 4D, each of the ribs 11 includes an upper portion or surface 11a. The upper surface 11a projects upward in a vertical direction from the middle layer 12 a distance of about 0.18″ (inches), according to an exemplary embodiment. A portion of each of the upper surfaces 11a cooperatively define the adaptable working surface configured to support various kitchen accessories, such as, for example, dishware, drinking glasses, pots, pans, utensils, or other similar types of accessories. The working surface, advantageously, adapts to the contours of the underlying surface that the mat 10 is placed on.

The ribs 11 also include a lower portion or surface 11b that projects downward in a substantially vertical direction from the middle layer 12 substantially the same distance as the upper surface 11a, according to an exemplary embodiment. That is, the lower surface 11b is the mirror image of the upper surface 11a. In this way, the mat 10 is reversible to provide a user with greater flexibility for use of the mat 10 in different applications. For example, referring again to FIGS. 1-2, the mat 10 can be placed in the bottom of a dishpan 20 or a sink basin 30 with the lower surfaces 11b contacting a bottom surface of the dishpan or sink basin. The upper surfaces 11a can receive (e.g., support, hold, etc.) one or more kitchen accessories to help facilitate cleaning or scrubbing of those accessories within the dishpan/sink basin. Likewise, the mat 10 can be flipped/reversed such that the upper surfaces 11a contact the bottom surface of the dishpan/sink basin such that the lower surfaces 11b provide the planar surface for receiving (e.g., supporting, holding, etc.) the various kitchen accessories. According to other exemplary embodiments, the middle layer 12 is positioned offset relative to the upper and lower surfaces 11a, 11b, such that the upper surface 11a projects a distance upward from the middle layer 12 that is different from the distance that the lower surface 11b projects downward from the middle layer 12.

Referring again to FIG. 4D, the middle layer 12 includes an upper surface 12a and a lower surface 12b. According to the exemplary embodiment of FIG. 4D, the middle layer 12 has a thickness of about 0.040″ (inches), although the middle layer 12 may be thinner or thicker, according to other exemplary embodiments. The middle layer 12 has a thickness sufficient to allow rolling or folding of the mat 10 into a substantially cylindrical shape to, for example, store the mat 10 for later use. However, the middle layer 12 is sufficiently ridged to support various kitchen accessories (e.g., plates, saucers, trays, etc.) within, for example, the dishpan 20 or the sink basin 30. The upper surface 12a of the middle layer 12 and a pair of upper surfaces 11a of the ribs 11 cooperatively define an upper channel of the mat 10. Similarly, the lower surface 12b and a pair of lower surfaces 11b of adjacent ribs 11 cooperatively define a lower channel of the mat 10. Each of the upper and lower channels includes a pair of vertical surfaces defined by adjacent ribs 11 that can cooperate to provide lateral support for a kitchen accessory to enable standing of the accessory in a substantially upright direction within, for example, a dishpan or a sink basin.

According to an exemplary embodiment, the upper and lower channels defined by the ribs 11 and the middle layer 12 are configured to receive and/or direct fluids (e.g., water, liquid soap, etc.) from, for example, one or more wet kitchen accessories to facilitate drying of those accessories. For example, referring again to FIG. 3, the mat 10 can be placed on a countertop 50. One or more wet cups or glasses 60 can be placed on the planar surface defined by the upper surfaces 11a of the ribs 11 for drying the accessories after being washed/rinsed. Water on the cups or glasses 60 can flow downward along the upper surfaces 11a within one or more of the upper channels toward the middle layer 12, where the water can rest and/or flow along, depending on the angle of orientation of the mat 10. Water can then evacuate from the mat 10 at an open end of the channels located along an outer side periphery of the mat 10. In this way, the mat 10 facilitates drying of various kitchen accessories, such as cups and glasses 60.

Similarly, the upper and lower channels defined by the ribs 11 and the middle layer 12 can facilitate draining of a dishpan or a sink basin with the mat 10 disposed therein. For example, referring to the kitchen accessory systems of FIGS. 1-2, the mat 10 may be placed within the dishpan 20 or the sink basin 30 adjacent a respective drain 26, 36. The mat 10 is configured to adapt to the shape or contour of the bottom wall 21, 31 of the dishpan/sink basin, respectively, such that the upper and lower channels are facing toward the drains 26, 36, respectively. A flow of water received within the dishpan/sink basin can flow, for example, along the bottom wall 21, 31 from an area near sidewall 24, 33 through the lower channels of the mat 10 past the ribs 11 toward the drain 26, 36. Similarly, water flowing on top of the mat 10 can flow within the upper channels of the mat 10 past the ribs 11 toward the drain 26, 36, depending on the contours or angles of the bottom wall of the dishpan/sink basin. Thus, the mat 10 can permit fluid flow within a dishpan or a sink basin to assist with draining of the dishpan/sink basin. According to other exemplary embodiments, the mat 10 can be used in other types of vessels, such as tubs, basins, or the like to facilitate draining of fluids therein.

According to an exemplary embodiment, the upper and lower channels defined by the ribs 11 and the middle layer 12 are further configured to receive and support various dishware (e.g., plates, saucers, trays, etc.) within a dishpan and/or a sink basin to enable standing of the dishware. For example, referring to the dishpan accessory system of FIG. 1, the mat 10 is shown disposed within the dishpan 20 along the bottom wall 21. The mat 10 is placed within the dishpan 20 such that an edge of the mat 10 abuts the sidewall 23 of the dishpan 20. According to an exemplary embodiment, the mat 10 may have a length such that the mat 10 abuts both the sidewall 23 and the sidewall 25 of the dishpan 20. A plate 40 is positioned within the dishpan 20 such that an edge of the plate 40 is received within an upper channel defined by a pair of ribs 11 and the middle layer 12. An upper portion of the plate 40 can rest against the sidewall 23 of the dishpan 20 while the pair of ribs 11 and the middle layer 12 provide vertical and lateral support to the plate 40, such that the plate 40 can stand in a substantially upright direction within the dishpan 20. The pair of ribs 11 and the middle layer 12 can, advantageously, prevent or impede the plate 40 from sliding (e.g., moving, translating, etc.) along the bottom wall 21 of the dishpan 20. The mat 10 also protects the bottom edge of the plate 40 from contacting a bottom of the dishpan 20. Furthermore, fluids present within the dishpan 20 or on the plate 40 can be directed toward the drain 26 by one or more of the lower and upper channels of the mat 10, respectively.

According to an exemplary embodiment, a plurality of plates 40 can be placed within adjacent upper channels of the mat 10 to enable standing of additional plates 40, or other similar kitchen accessories, within the dishpan 20. In this manner, the mat 10 enables standing of one or more plates 40 within the dishpan 20 to facilitate drying, cleaning, and/or organization of the plates 40 or other suitable dishware or accessories (e.g., saucers, trays, etc.).

Similarly, referring again to the sink accessory system of FIG. 2, the mat 10 is disposed within a sink basin 30 along the bottom wall 31. The mat 10 is placed within the sink basin 30 such that an edge of the mat 10 abuts the partition wall 32 of the sink basin 30. According to an exemplary embodiment, the mat 10 may have a length such that the mat 10 abuts both the partition wall 32 and the sidewall 35 of the dishpan 30. A plate 40 is positioned within the sink basin 30 such that an edge of the plate 40 is received within an upper channel defined by a pair of ribs 11 and the middle layer 12. An upper portion of the plate 40 can rest against the partition wall 32 of the sink basin 30 while the pair of ribs 11 and the middle layer 12 provide vertical and lateral support to the plate 40, such that the plate 40 can stand in a substantially upright direction within the sink basin 30. The pair of ribs 11 and the middle layer 12 can, advantageously, prevent or impede the plate 40 from sliding (e.g., moving, translating, etc.) along the bottom wall 31 of the sink basin 30. The mat 10 also protects the bottom edge of the plate 40 from contacting a bottom of the sink basin 30. Furthermore, fluids present within the sink basin 30 or on the plate 40 can be directed toward the drain 36 by one or more of the lower and upper channels of the mat 10, respectively. In this way, the mat 10 enables standing of one or more plates 40 within the sink basin 30 to facilitate drying, cleaning, and/or organization of the plates 40 or other suitable kitchen accessories (e.g., saucers, trays, etc.).

According to an exemplary embodiment, the mat 10 is made from a soft, flexible material that is configured to provide sufficient frictional resistance relative to a support surface (e.g., a bottom surface of a dishpan, a sink basin, a countertop, etc.) such that the mat does not slide when contacting the surface. That is, the mat 10 is made from a material that has a coefficient of friction sufficient to prevent or impede movement (e.g., bunching, sliding, etc.) of the mat 10 when the mat 10 is in contact with a support surface. The mat 10 is also sufficiently flexible such that it can adapt to the contours of the surface it contacts, such as, for example, a bottom surface of a dishpan or a sink basin. According to an exemplary embodiment, the mat 10 is formed (e.g., molded, extruded, etc.) from a silicone material that is substantially impervious to moisture. According to other exemplary embodiments, the mat 10 is formed from another soft, flexible material that is substantially impervious to moisture and that is suitable for the particular application of the mat 10 within a sink basin, a dishpan, on a countertop, or other similar environment.

According to various exemplary embodiments, when the mat 10 is not in use, the mat can be stored in a variety of different ways. For example, referring to FIG. 5, the mat 10 is sufficiently flexible to enable a user to fold the mat 10 over a partition wall 32 of a sink basin 30 to store the mat 10 for later use. The mat 10 is configured to substantially conform to the contours of the partition wall 32 such that the mat 10 does not obstruct/prevent a user from accessing the sink basin 30. Furthermore, the mat 10 has a length sufficient to avoid contact with the bottom wall 31 of the mat 10 when the mat 10 is folded over the partition wall 32, so as to prevent the mat 10 from getting wet and/or contacting other fluids that may be present within the sink basin 30.

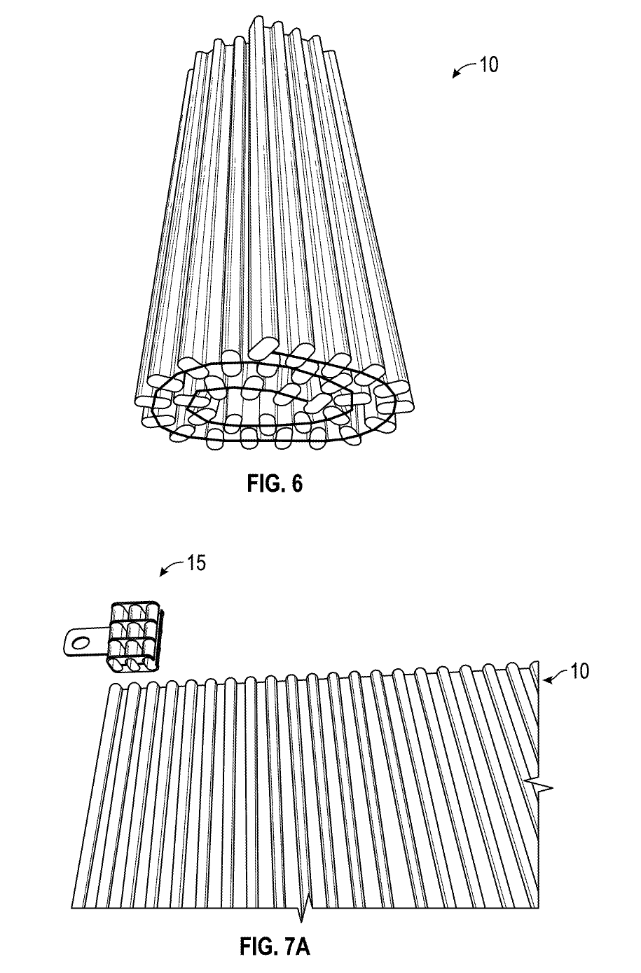

According to another exemplary embodiment shown in FIG. 6, the mat 10 is sufficiently flexible such that the mat 10 can be rolled into a compact, substantially cylindrical shape for storage and the like. For example, a user can roll/fold the mat 10 against itself and the ribs 11 can engage respective upper and lower channels of the mat to facilitate rolling and/or folding of the mat 10. In this way, the mat 10 can be easily stored without taking up a significant amount of storage space (i.e., a smaller storage footprint).

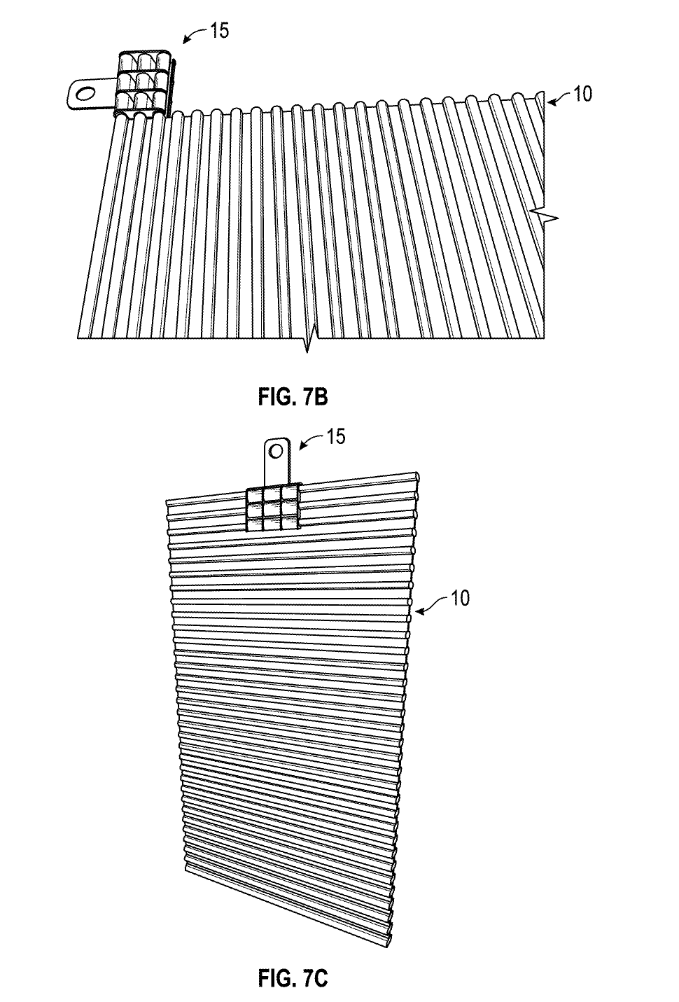

Referring now to FIGS. 7A-7C, the mat 10 includes a hanger 15 for hanging, storing (e.g., in a kitchen environment, etc.) and/or displaying (e.g., in a retail environment, etc.) the mat 10. As shown in FIG. 7A, the hanger 15 is shown disengaged from the mat 10. The hanger 15 includes two flexible sections connected to a tab extending therefrom. The tab includes an eyelet configured to engage a hook or other similar feature to hang the mat 10 (e.g., for storage and/or for display). Each of the flexible sections includes one or more ribs that have a shape that is complimentary to a profile of the mat 10.

Referring now to FIGS. 7B-7C, the flexible sections of the hanger 15 are configured to engage the ribs 11 and the middle layer 12 so as to retain/hold the mat 10. That is, the ribs defined by the flexible sections are configured to be received within one or more of the upper and lower channels of the mat 10. As shown in FIG. 7B, the hanger 15 can be slid over a portion of the mat 10 (denoted by the arrow in FIG. 7B) such that the ribs of each of the flexible sections are received within one or more of the upper and lower channels of the mat 10. The hanger 15 can be slid near the middle of the mat 10 to facilitate hanging of the mat 10 via the eyelet of the tab. If the mat 10 needs to be accessed for use, a user can simply slide the mat 10 relative to the hanger 15 so as to disengage the flexible sections from the upper and lower channels of the mat. In this way, the hanger 15 allows for simple hanging and removal of the mat 10, such as for display in a retail setting and/or storage within a kitchen environment.

According to an exemplary embodiment, the hanger 15 is formed (e.g., molded, etc.) from a polymer having a modulus of elasticity sufficient to enable elastic deformation of the flexible sections such that the hanger 15 can be slid over and removed from the mat 10. According to other exemplary embodiments, the hanger 15 is formed from another rigid or semi-rigid material suitable for the particular application of the hanger 15.

The various kitchen accessory systems including the mat 10 disclosed herein enable standing of various dishware (e.g., plates, saucers, etc.), facilitate draining of fluids and/or drying of various kitchen accessories (e.g., pots, pans, dishware, utensils, drinking glasses, etc.), provide a soft, flexible surface for cleaning various kitchen accessories, and are flexible to permit ease of storage and use in a variety of different applications (e.g., sinks having different shapes and contours, etc.).

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the application as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present application.

What is claimed is:

1. A dish mat comprising:
a middle layer having a top surface and a bottom surface; and
a plurality of ribs extending from each of the top and bottom surfaces of the middle layer;
wherein the plurality of ribs are spaced laterally apart from each other such that the plurality of ribs and the middle layer collectively define a plurality of upper and lower channels.

2. The mat of claim 1, wherein each of the plurality of ribs includes a vertical surface configured to provide lateral support for a kitchen accessory disposed within each of the upper or lower channels to enable standing of the kitchen accessory in a substantially upright direction.

3. The mat of claim 1, wherein the plurality of upper and lower channels each extend continuously between outermost side peripheries of the mat to direct fluid outwardly away from the mat.

4. The mat of claim 1, wherein the plurality of ribs extend continuously between outermost side peripheries of the mat, and wherein the plurality of ribs are spaced equidistant from each other.

5. The mat of claim 1, wherein the plurality of ribs each include an upper surface that collectively define a first adaptable support surface configured to support one or more kitchen accessories thereon.

6. The mat of claim 5, wherein the plurality of ribs each include a lower surface located opposite the upper surface that collectively define a second adaptable support surface configured to support one or more kitchen accessories thereon.

7. The mat of claim 1, wherein the middle layer has a generally planar shape and a thickness of about 0.04 inches.

8. The mat of claim 1, wherein each of the plurality of ribs extends from the top and bottom surfaces of the middle layer a distance of about 0.18 inches, respectively.

9. The mat of claim 1, wherein the mat is configured to be rolled into a substantially cylindrical shape.

10. A dish mat for a sink basin comprising:
a middle layer having a top surface and a bottom surface; and
a plurality of ribs extending outwardly from each of the top and bottom surfaces of the middle layer;
wherein the plurality of ribs are spaced laterally apart from each other such that the plurality of ribs and the middle layer collectively define a plurality of upper and lower channels;
wherein the plurality of upper and lower channels are each configured to:
provide vertical and lateral support for a kitchen accessory to enable standing of the kitchen accessory in a substantially upright direction within the sink basin, and
direct fluid outwardly away from the dish mat.

11. The mat of claim 10, wherein each of the plurality of ribs includes a vertical surface configured to provide lateral support for a kitchen accessory disposed within each of the upper or lower channels.

12. The mat of claim 10, wherein the plurality of upper and lower channels each extend continuously between outermost side peripheries of the mat to direct fluid outwardly away from the mat.

13. The mat of claim 10, wherein the plurality of ribs extend continuously between outermost side peripheries of the mat, and wherein the plurality of ribs are spaced equidistant from each other.

14. The mat of claim 10, wherein the plurality of ribs each include an upper surface that collectively define a first adaptable support surface configured to support one or more kitchen accessories thereon.

15. The mat of claim 14, wherein the plurality of ribs each include a lower surface located opposite the upper surface that collectively define a second adaptable support surface configured to support one or more kitchen accessories thereon.

16. A dish mat comprising:
a middle layer having a top surface and a bottom surface; and
a plurality of ribs projecting from the top and bottom surfaces of the middle layer and extending continuously between outermost side peripheries of the mat;
wherein the plurality of ribs are spaced laterally apart from each other such that the plurality of ribs and the middle layer collectively define a plurality of upper and lower channels;
wherein the plurality of upper and lower channels are each configured to direct fluid outwardly away from the dish mat.

17. The mat of claim 16, wherein the dish mat is sufficiently flexible to adapt to a shape of a support surface for receiving the dish mat thereon.

18. The mat of claim 16, wherein the plurality of upper and lower channels each extend continuously between outermost side peripheries of the mat to direct fluid outwardly away from the mat.

19. The mat of claim 16, wherein the plurality of ribs each include an upper surface that collectively define a first adaptable support surface configured to support one or more kitchen accessories thereon.

20. The mat of claim 19, wherein the plurality of ribs each include a lower surface located opposite the upper surface that collectively define a second adaptable support surface configured to support one or more kitchen accessories thereon.
